(19) United States
(12) Patent Application Publication
(10) Pub. No.: US 2008/0043855 A1
(43) Pub. Date: Feb. 21, 2008

(54) Method and Apparatus for Encoding of Low Voltage Swing Signals

(75) Inventors: Rohini Krishnan, Eindhoven (NL); Jose de Jesus Pineda De Gyvez, Eindhoven (NL)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: KONINKLIJKE PHILIPS ELECTRONICS N.V., NL-5621 BA Eindhoven (NL)

(21) Appl. No.: 10/565,860

(22) PCT Filed: Jul. 12, 2004
(86) PCT No.: PCT/IB04/51194

§ 371 Date: Jan. 23, 2006

(30) Foreign Application Priority Data
Jul. 22, 2003 (EP) 03102246.0

(51) Int. Cl. H04B 3/02; H04L 25/49; H04L 27/00

(52) U.S. Cl. 375/257; 375/295; 375/296

(57) ABSTRACT

An encoded-low swing scheme for transmission of a signal across an interconnect bus whereby the current values to be transmitted on the bus are compared with the previous state of the bus. When the number of bits flipping is greater than N, where N is the width of the bus, the decision to transmit the inverted signal values is made. In addition, an “invert” signal is also sent to the receiver to indicate whether the bus values are inverted or not. These encoded values are then converted into their low swing equivalents and transmitted. In this way, it can be ensured that the energy consumed over the interconnect is minimum. This strategy not only reduces the probability of transitions over the interconnect but also transmits only low swing values to achieve tremendous energy reductions relative to conventional techniques.

This invention relates to low voltage swing techniques and, more particularly, to a method and apparatus for employing low voltage swing techniques to reduce power consumption in interconnecting bus lines on an integrated circuit.

As process geometries continue to shrink, the interconnects and the drivers and receivers associated with them are among the major energy consumers on an integrated circuit. As more complex circuits are integrated in a single chip, with global buses, clock lines and timing circuits running across the chip, the fraction of energy consumed by the interconnect is ever increasing. For example, the fraction of energy dissipated over conventional gate array based designs has been found to be 40%, for cell-library based designs it has been found to be 50%, -and for traditional FPGA devices it has found to be 90%.

Methods to reduce the amount of energy consumed by an interconnect have been extensively researched. Reducing the voltage swing of the signal on the wire has been one of the most efficient techniques for reducing the power quadratically and power-delay product linearly. For example, U.S. Pat. No. 6,570,415 describes a reduced voltage swing digital differential driver. Predrivers drive the inputs of a differential comparator to a specified level. In conventional predrivers, since the signals sent to the differential comparator are digital, the voltage at its output swings from ground to the full power supply voltage level. As a result, the switching speed is slow and the power consumption is high. U.S. Pat. No. 6,570,415 attempts to overcome these problems by providing an arrangement in which the predriver is arranged such that when the input of the differential comparator reaches a predetermined threshold voltage, the discharge path is disabled. Thus, on the next cycle, the input gate will only need to start charging from the threshold voltage, instead of ground, thereby reducing the voltage swing. As a result, current consumption taken from the predriver power supply is reduced and switching speed is improved.

However, conventional low swing techniques suffer from low noise immunity and reduced signal-to-noise ratios.

We have now devised an improved arrangement.

In accordance with the present invention, there is provided apparatus for transmitting an n-bit digital signal across an interconnect, where n is the width of said bus, the apparatus comprising means for converting said digital signal into its low swing equivalent, the apparatus being characterized by means for encoding said signal, prior to transmission thereof, so as to reduce the number of bits which change in a current signal to be transmitted relative to the bits of the signal transmitted previously.

Also in accordance with the present invention, there is provided a method for transmitting an n-bit digital signal across an interconnect, where n is the width of said bus, the method comprising the steps of converting said digital signal into its low swing equivalent, and being characterized by the step of encoding said signal, prior to transmission thereof, so as to reduce the number of bits which change in a current signal to be transmitted relative to the bits of the signal transmitted previously.

In a preferred embodiment of the present invention, the means for encoding preferably comprises means for comparing the values of the current signal to be transmitted with the values of a signal transmitted previously, determining whether or not the number of bits of said current signal which are of opposite value to the corresponding bits of the previous signal exceeds some predetermined threshold value, and only encoding said current signal if said predetermined threshold value is exceeded.

In one embodiment of the invention, if the width of the interconnect N is odd, the threshold could be (N+1)/2 and, if N is even, the threshold could be N/2.

One type of encoding which may be employed, is bus invert coding, whereby if the number of bits that “flip” exceeds the predetermined threshold value, all of the bits of the current signal to be transmitted across the interconnect are inverted prior to transmission thereof, and an “invert” signal is also transmitted, to indicate to the receiver that the signal has been inverted. However, it will be appreciated that many known encoding techniques are known in the art for reducing the number of bits “flipping” between two successive signals. Similarly, many known techniques exist for converting a signal into its low swing equivalent, and the invention is not intended to be limited in this respect. The encoding technique chosen could be targeted for low energy, and/or reducing crosstalk noise, and/or improving robustness, and/or improving signal-to-noise ratios, and/or improving speed etc.

The present invention provides ultra-low power consumption in interconnect bus lines, significantly improved signal-to-noise ratio compared with conventional arrangements and an improved energy delay product.

These and other aspects of the invention will be apparent from and elucidated with reference to the embodiment described hereinafter.

An embodiment of the present invention for low energy purposes will now be described by way of example only and with reference to the accompanying drawings, in which:

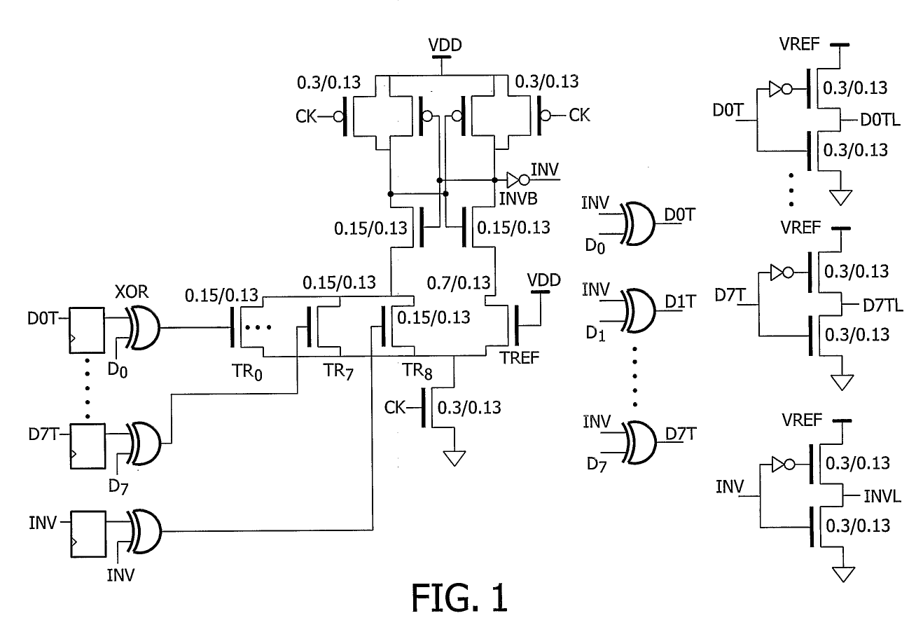

FIG. 1 is a schematic circuit diagram illustrating an encoded low swing transmitter for 8 bits according to an exemplary embodiment of the present invention; and

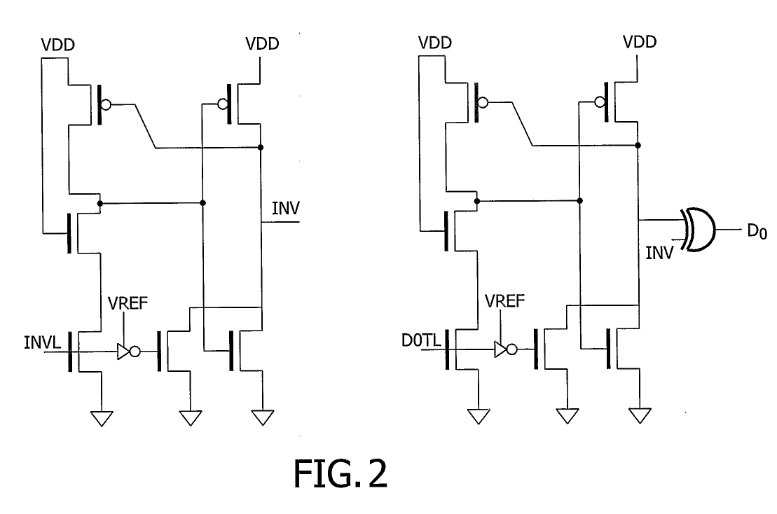

FIG. 2 is a schematic circuit diagram illustrating an encoded low swing receiver according to an exemplary embodiment of the present invention.

First, a brief overview of an exemplary embodiment of the method of the present invention will be presented, where the encoding, as already mentioned, is targeted for low energy. In this exemplary embodiment of an encoded-low swing scheme, the current values to be transmitted on the bus are compared with the previous state of the bus. When the number of bits flipping is greater than N/2 where N is the width of the bus, the decision to send the inverted signal values is made. In addition, an “invert” signal is also sent to the receiver to indicate whether the bus values are inverted or not. These encoded values are then converted into their low swing equivalents and transmitted. In this way, it can be ensured that the energy consumed over the interconnect is minimum. This strategy not only reduces the probability of transitions over the interconnect but also transmits only low swing values to achieve tremendous energy reductions relative to conventional techniques. This energy saving can only be optimized, however, if an efficient driver and received circuit is used, which does not consume more energy than is saved over the interconnect. For that, an efficient circuit implementation will be described later.

First, however, the energy savings that are possible using the proposed technique will be estimated. The average number of transitions can be estimated using probabilistic analysis for a N bit wide bus. The dynamic switching energy of the bus is given by Eqn. 1.

E_{dyn}=C_{average}V_{ref}²T (1)

In Eqn. 1, T is the total number of transitions over the wire. Without encoding, the transitions, TNE, for an average case for a N bit wide bus is

$${T}_{NE} = {\sum }_{M = 1}^{N} P ( M ) \cdot M \qquad ( 2 )$$

where TNE denotes the number of transitions without encoding. P(M) denotes the probability that M bits flip in a N bit wide bus and is given by

$$P ( M ) = \frac{1}{{2}^{N}} C ( \begin{matrix}N \\ M\end{matrix} ) = \frac{1}{{2}^{N}} \frac{N !}{( N - M ) ! M !} \qquad ( 3 )$$

By using the bus-invert coding method, we compute the transitions for an average case for a N bit wide bus. Those skilled in the art could extend this analysis for other encoding techniques which could target other performance requirements (reduced noise codes, increased robustness codes, other low energy codes, high speed codes etc) by properly calculating P(M) and using the appropriate thresholds.

In a preferred embodiment, the cases when N is odd and N is even are differentiated between. This is shown next.

1. Case a: When N is odd. Using bus invert coding, the number of transitions is given by Eqn. 4. T_{E} indicates the number of transitions over the bus in the presence of encoding. Here, when the number of bit flips exceeds

$$\frac{N + 1}{2} - 1 ,$$

the decision to invert the data bits is made. Counting the extra transition due to the invert signal, the number of transitions over the bus, when

$$\frac{N + 1}{2}$$

data bits flip, is

$$N - \frac{N + 1}{2} + 1 = \frac{N + 1}{2} . \\ {T}_{E} = \frac{1}{{2}^{N}} [ 1 C ( \frac{N}{1} ) + 2 C ( \frac{N}{2} ) + … + ( \frac{N + 1}{2} ) C ( \frac{\begin{matrix}N \\ N + 1\end{matrix}}{2} ) + ( \frac{N + 1}{2} = 1 ) C ( \frac{\begin{matrix}N \\ N + 1\end{matrix}}{2} + 1 ) + ( \frac{N + 1}{2} - 2 ) C ( \frac{\begin{matrix}N \\ N + 1\end{matrix}}{2} + 2 ) + … + 1 C \frac{N}{N} ] \qquad ( 4 )$$

2) Case b: When N is even: Here, when the number of bit flips is exactly N/2, there is no advantage in encoding. The decision to invert the values on the bus if it does not cause a transition over the “invert” signal itself can be made. This means that when N is even, an extra state flip flop for storing the state of the “invert” signal is needed in this exemplary embodiment, which is not the case when N is odd.

$${T}_{E} = \frac{1}{{2}^{N}} [ 1 C ( \begin{matrix}N \\ 1\end{matrix} ) + 2 C ( \begin{matrix}N \\ 2\end{matrix} ) + … + ( \frac{N}{2} + 1 ) C ( \frac{\begin{matrix}N \\ N\end{matrix}}{2} ) + \frac{N}{2} C ( \frac{\begin{matrix}N \\ N\end{matrix}}{2 + 1} ) + ( \frac{N}{2} - 1 ) C ( \frac{\begin{matrix}N \\ N\end{matrix}}{2} + 2 ) + … + 1 C ( \begin{matrix}N \\ N\end{matrix} ) ] \qquad ( 5 )$$

An efficient exemplary implementation of the driver for an 8 bit wide bus using an analog majority voter circuit is illustrated as shown in FIG. 1. The receiver circuit is shown in FIG. 2. The current state of the bus (D0T, D1T, . . . , D7T, INV) is compared with the new values to be transmitted. If majority of the bits have flipped, the analog majority voter sets the INVB signal (shown in FIG. 1) too high. The advantage of using the analog majority voter circuit is that it is easily scalable to larger bus widths with very little extra area overhead. The encoded signal values are then converted into a low swing value using a conventional NMOS-only push-pull driver. The driver and receiver circuits consume very little power. In the driver, in the analog majority voter circuit, by using the clock as the gate signal for the PMOS transistors in the latch and for the NMOS transistor (at the bottom) acting as a current source, it can be ensured that there is never a path from the power supply to ground except during the clock transitions. In the receiver, since cascade circuitry and differential circuits are used, the short circuit current is reduced. The receiver consists of a low-swing restorer and a decoder as shown in FIG. 1. The decoder consists simply of XOR gates, which uses the “invert” signal to either invert or not-invert the received values depending on whether the “invert” signal is 1 or 0.

Thus the above-described method and apparatus provides a novel encoded-low swing technique and an efficient circuit implementation of the same. It has been found that this achieves the best energy-delay product over the existing schemes when the capacitive load over the interconnect begins to increase above 200fF. Analyses of simulation results carried out show that the average energy-delay product of the proposed technique is superior by 45.7% with respect to techniques using only low swing, and by 75.8% with respect to techniques using only encoding averaged over data streams. This gain could vary depending on the data streams used. In the presence of crosstalk noise, it can be shown that the proposed technique has the best energy-delay product even for small capacitive loads (CL≦200fF). The signal to noise ratio of the proposed technique is superior to existing low swing techniques by 8.8%. The method and apparatus of the present invention is applicable to general IC's (SoC—System on Chip) ASIC's and FPGA's to reduce power. It has been found to be especially useful for dealing with buses which have a large capacitance associated with them and dissipate power. It can also be applied to reduce Input/Output power dissipated since dimensions of the devices in the I/O pads of chips are large since they have to drive large external capacitances due to wires, I/O pins and connected circuits.

FPGA interconnects, either present in platform FPGAs or embedded FPGAs could potentially benefit a lot from the proposed technique since the capacitive load over the programmable switch based interconnect is high. Even other programmable interconnects could use this technique to achieve different performance targets (low energy, increased robustness etc).

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. Apparatus for transmitting an n-bit digital signal across an interconnect, where n is the width of said interconnect, the apparatus comprising means for converting said digital signal into its low swing equivalent, the apparatus being characterized by means for encoding said signal, prior to transmission thereof.

2. Apparatus according to claim 1, wherein the encoding is targeted for low energy characterized by reducing the number of bits which change in a current signal to be transmitted relative to the bits of the signal transmitted previously.

3. Apparatus according to claim 1, wherein the encoding is targeted for reducing crosstalk induced noise.

4. Apparatus according to claim 1, wherein the encoding is targeted for reducing crosstalk induced delay.

5. Apparatus according to claim 1, wherein the encoding is targeted for increasing robustness of the data transmitted.

6. Apparatus according to claim 1, being used in respect of programmable logic devices, specifically FPGAs (embedded or stand-alone), to reduce energy increase robustness by improving signal integrity, reducing crosstalk, and/or reduce delay.

7. Apparatus according to claim 1, wherein the means for encoding said signal comprises means for comparing the values of the current signal to be transmitted with the values of a signal transmitted previously, determining whether or not the number of bits of said current signal which are of opposite value to the corresponding bits of the previous signal exceeds some predetermined threshold value, and only encoding said current signal if said predetermined threshold value is exceeded.

8. Apparatus according to claim 7, wherein if the width of the interconnect being coded is even, the predetermined threshold value is nix, where x is an even integer.

9. Apparatus according to claim 8, wherein x=2.

10. Apparatus according to claim 7, wherein if the width of the interconnect being encoded is odd, the predetermined threshold value is [(n+1)/2]−1.

11. Apparatus according to claim 1, further including a receiver.

12. Apparatus according to claim 11, wherein the type of encoding employed by said encoding means is bus invert coding, whereby if the number of bits that “flip” exceeds the predetermined threshold value, all of the bits of the current signal to be transmitted across the interconnect are inverted prior to transmission thereof, and an “invert” signal is also transmitted, to indicate to said receiver that said signal has been inverted.

13. A method for transmitting an n-bit digital signal across an interconnect, where n is the width of said interconnect, the method comprising the steps of converting said digital signal into its low swing equivalent, and being characterized by the step of encoding said signal, prior to transmission thereof.

14. A method according to claim 13, wherein said step of encoding said signal comprises the steps of comparing the values of the current signal to be transmitted with the values of a signal transmitted previously, determining whether or not the number of bits of said current signal which are of opposite value to the corresponding bits of the previous signal exceeds some predetermined threshold value, and only encoding said current signal if said predetermined threshold value is exceeded.

15. A method according to claim 14, wherein if the width of the interconnect being encoded is even, the predetermined threshold value is nix, where x is an even integer.

16. A method according to claim 15, wherein x=2.

17. A method according to claim 14, wherein if the width of the interconnect being encoded is odd, the predetermined threshold value is (n+1)/2−1.

18. A method according to claim 13, including the step of providing a receiver for receiving the transmitted signal.

19. A method according to claim 18, wherein the type of encoding employed is bus invert coding, whereby if the number of bits that “flip” exceeds the predetermined threshold value, all of the bits of the current signal to be transmitted across the interconnect are inverted prior to transmission thereof, and an “invert” signal is also transmitted, to indicate to the receiver that signal has been inverted.
